(19) United States
(12) Patent Application Publication
(10) Pub. No.: US 2016/0244318 A1
(43) Pub. Date: Aug. 25, 2016

(54) PANIC SNAP

(71) Applicant: Rudolf LINNER, Seeon (DE)

(72) Inventors: Rudolf LINNER, Seeon (DE); Linner Hans, Seeon (DE)

(21) Appl. No.: 14/787,457

(22) PCT Filed: Apr. 29, 2014
(86) PCT No.: PCT/DE2014/000224

§ 371 Date: Mar. 30, 2016

(30) Foreign Application Priority Data
Apr. 30, 2013 (DE) 10 2013 007 433.9

(51) Int. Cl. B68B 5/00; F16B 45/02; A01K 27/00

(52) U.S. Cl. CPC B68B 5/00; A01K 27/005; F16B 45/02

(57) ABSTRACT

The invention relates to a panic snap, in particular on lead and tether lines for horses. FIG. 4 shows the lengthwise cross-section of the load part (1) and the cross section of the halter ring (31). The snap (11), in the form of a rocker mounted in the load part (1), is blocked by means of the wedge blocking mechanism (21) in order to retain the halter ring (31). By pushing the grip sleeve (19) on the load part (1) back towards the pressure spring (29), the wedge blocking mechanism (21), which is molded on the grip sleeve (19), is pulled out from under the blocking arm (16), and the snap (11) is freed. If the grip sleeve (19) is released, the wedge blocking mechanism (21) is pushed back under the blocking arm (16) by the spring pressure and thus closes the snap (11). In comparison to conventional panic snaps, the panic snap according to the invention can be opened more easily under loads and is more comfortable and time-saving to handle. The panic snap is to be produced with few individual parts so as to be inexpensive.

The invention to be presented here relates to a clip connector, which can be released rapidly under load. Such a connector is referred to as a panic snap in some areas of application, such as, for example, in horse keeping on halters for leading and tethering of horses or in sport equipment pulled by a kite—for example, kite surfing—as part of the connection between the sportsperson and the kite. In parachute jumping, too, connectors that can be released under load are necessary components of the equipment.

In horse keeping, it is necessary to provide the line for tethering a horse with a panic snap, since, if a tethered horse should become panicked, it will tug on this tether line with all its force. The horse keeper has to be capable of releasing the snap on the strained line. A kite surfer must likewise be able to release lines under load in order that the kite can get out of the wind if danger threatens when, for example, there is too strong a gust or an obstacle is encountered.

The generally employed panic snap on tether lines for horses is based on the Utility Model Specification DE 20 2008 007 962 U1 of Grünau (2008). As required, it can open under load, but it has a number of drawbacks: It requires some finger force to pull back the sleeve and thus expose the movable snap part. Furthermore, the sleeve is so small that it can be gripped only between thumb and index finger. In the case that a tethered horse becomes panicked and tugs on the tether line, it is not easy to grasp the small sleeve. Because the sleeve becomes more difficult to pull back with increasing tensile load, it is not possible at all for one person with little physical strength to open this conventional panic snap under some circumstances.

Snapping of the conventional panic snap is awkward, since it is first necessary to place the movable part of the snap around the halter ring, then push back the sleeve against the spring force and hold the movable part of the snap in this position with a finger until the released sleeve secures the movable part of the snap. When the panic snap is released, the sluggish design results each time in a tug on the horse's mouth, which one would like to prevent. In addition to this, there is the detrimental property that, in spite of the movable part of the snap that has already been released, the fixed part of the snap often remains clipped on the halter ring while the horse is already tugging. This can even pose a danger when horses are being led on the paddock and they break loose once they hear the noise of the opening snap. Moreover, it can occur that these panic snaps open by themselves when there is a backward tug. Finally, the conventional panic snap, made entirely of metal, is very heavy at 140 grams; if this panic snap springs open unexpectedly when it is released under tension, it can injure the horse keeper or the horse. In general, the conventional panic snap feels clumsy and awkward because of the required strong return spring of the sleeve.

A variant of the conventional panic snap is presented in the Utility Model Application DE 8613 925 U1 of the Batz company (1986). Instead of a displaceable sleeve, a rotatable sleeve is proposed for retaining and releasing the movable snap. This design is somewhat easier to open under load, but the snapping in place is more awkward. Although this variant is commercially available, it is very seldom offered.

Instead of the conventional panic snap, carabineer clips are often used on lead lines. They can be clipped on the halter ring more simply. However, they have the drawback during clipping that the carabineer clip has to be free of tension. For this reason, carabineer clips are not suitable for tethering, either. Thus, in the final analysis, the tether line with a panic snap is also utilized as a lead line in most cases so that the lead line and tether line do not have to be at hand for each horse.

For parachutes and for kite surfers, there are a large number of connectors that can release under load (“quick release,” “emergency release”), such as, for example, U.S. Pat. No. 3,380,692 of Gaylord (1968). The Patent Specification U.S. Pat. No. 8,146,215 B2 of Sadeck (2012) describes a universal connector that can release under load. Multiple loops with laces and cords are required for closing it. A practicable and advantageous panic snap for horses or for sport equipment pulled by kite cannot be inferred from this and all other solutions. Many kite surfers use a so-called wichard, similar to Utility Model DE 299 01 180 U1 of Hölscher, as panic snap. However, the problem here is that, with increasing tensile load, quite a large force is required to open the connector.

The problem is therefore posed of creating a connector with a minimum number of parts that can release under load, wherein the unsnapping should be more effortless and secure against jamming even at high loads. A natural and sparing movement should suffice for snapping it in place. First and foremost, a panic snap for horse keeping is to be created, wherein, in the case of panic, the element can be grasped more easily in order to release it. However, it should be possible to extend the functional principle to all areas in which a rapid release of belt, chain, or cord connectors under load is demanded.

The problem is solved by the features described in the main claim.

Accordingly, the panic snap according to the invention is based on the following principle: a snap is designed in the form of a rocker, which is mounted on a load part. The form of the snap is determined by a load arm on one side of a snap axis hole and an opposite-lying blocking arm and an opening lug molded on it. Together with claw appendage molded on the load part, the load arm of the snap forms a pincher that can be opened and closed. As a result, a ring or the loop of a cord can be grasped. In order to be able to accommodate a tensile load, the snap has to be fixed in the closed position. This occurs in that a blocking wedge, movably mounted in the load part, is pushed under the blocking arm of the snap. If the blocking wedge is pulled out from under the blocking arm, the snap opens by itself, on the one hand, owing to an applied tensile force and, on the other hand, it is forced open by an opening pin joined to the blocking wedge, when no tensile force is applied. At this instant, the opening pin engages the opening lug of the snap, because the blocking wedge is fully pulled away under the blocking arm.

The geometry of the snap is governed in this process by the following criteria: On the one hand, the snap has to securely release the snapped ring or the loop of the cord when the blocking wedge is pulled back and, on the other hand, the pressure of the load arm of the snap on the blocking wedge should be as small as possible in order to keep the frictional resistance as small as possible when the blocking wedge is pulled back and thus minimize the required force for releasing the connector. These demands are fulfilled in that the center of the cross section of a snapped ring or the loop of a cord, the snap axis hole as point of rotation of the snap, and the middle of the cross section of the blocking wedge lie on a line of force. If, in this arrangement, the contact area of the snapped ring or the loop of the cord were to lie at a right angle to the line of force at the load arm, the blocking arm of the snap would theoretically exert no force on the blocking wedge and, correspondingly, the snap would not open if the blocking wedge were pulled back. For this reason, the part of the load arm on which a tensile force can be applied is sloped at an angle of less than 90°; it is referred to as the flat load area.

As a result, on the one hand, a small part of the tensile load is diverted as pressure onto the blocking wedge, but, on the other hand, the snapped ring or the loop of the cord slides off the flat load area and thereby opens the snap once it is free because the blocking wedge has been pulled back. In order to ensure that a snapped ring or a loop of a cord reaches the flat load area under the smallest tensile force, a subsequent stronger sloping on the snap in the form of a steep load area allows the snapped ring or a loop of a cord to slide off there.

In the default state, the panic snap according to the invention is closed. A pressure spring placed in the load part acts on a pressure spring pin, which is joined permanently to the blocking wedge and the opening pin. This pressure spring thereby pushes the blocking wedge under the blocking arm and closes and blocks the snap. In order to open the snap, the user has to pull back the blocking wedge against the resistance of the pressure spring on the pressure spring pin.

The panic snap according to the invention is explained below by way of example of the design for tether lines in horse keeping. Here, the blocking wedge, pressure spring pin, and opening pin, which are joined elements, are molded on the inner side of a right recessed grip. These elements each engage in the load part through a blocking wedge recess, a pressure spring pin recess, and an opening pin recess. A left recessed grip is permanently joined with the right recessed grip to form a grip sleeve, which surrounds the load part. The grip sleeve can be displaced on the load part by the distance of travel that is required to push the blocking part completely under the blocking arm and, in the opposite direction, the opening lug of the snap can be pulled back with the opening pin such that the snap is opened maximally.

The panic snap according to the invention is formed in this exemplary embodiment according to ergonomic aspects: A closing cap over a snap pocket in the load part serves as a thumb rest, while an index finger rest and a middle finger depression are molded on the grip sleeve. The user opens the snap by pushing the load part away from him with the thumb on the closing cap, while, at the same time, he pulls toward him the grip sleeve with the index finger on the index finger rest or with the middle finger in the middle finger depression. In this exemplary embodiment, the distance of travel is only 11 mm, so that the thumb or the index and middle finger each have to move only by 5.5 mm in order to open the snap maximally. In order to close the snap, the user needs only to release the grip sleeve, since the pressure spring immediately lets the grip sleeve spring forward, so that the snap is blocked instantly against the maximum tensile forces. In order to release the panic snap from the halter, the user need only grasp the grip sleeve and pull it away from the halter. In doing so, the user feels practically only the slight resistance of the pressure spring, since the halter ring slides from the snap with nearly no resistance. Correspondingly, practically no tug acts on the horse's mouth.

If, in the case of emergency, the panic snap according to the invention is placed under strong tensile load, a certain frictional resistance between the blocking wedge and the blocking arm needs to be overcome, but, owing to the described geometry of the snap, this resistance is so small that, in contrast to conventional panic snaps, even a person of low strength can easily release the panic snap according to the invention, especially since the grip sleeve has a large and ergonomically favorable grip area, likewise in contrast to conventional panic snaps.

Only the snap and the axis are made of steel; all other parts can be manufactured by injected molding methods from glass-fiber-reinforced plastic. The panic snap according to the invention therefore weighs only 65 grams, that is, less than half of the weight of the conventional panic snap. This reduces the risk of injury, especially since protective flanks made of plastic surround the steel snaps.

The panic snap according to the invention is composed of only 7 parts, which are also designed for simple assembly steps: First of all, the snap is pushed into the snap pocket in the load part, the axis is inserted through the load part axis hole and the snap axis hole, and the closing cap is inserted onto the load part; this subassembly is placed in the right recessed grip, so that the molded projections thereof pass through the corresponding recesses in the load part. The pressure spring is pressed with pretension on the pressure spring pin into the spring chamber. Finally, the left recessed grip is inserted onto the locking pin of the right shell.

In comparison to conventional panic snaps, the panic snap according to the invention can thus be snapped in place more simply and more rapidly, unsnapped more simply, more rapidly, and more safely, and, in the case of an emergency, is easier to grip and open with less application of force; it is generally less prone to cause injury owing to its lower weight and complete encasing in plastic and it can be manufactured in large unit numbers in a similarly low-cost manner. Moreover, it can be used without modification with all described advantages for sport equipment pulled by kites.

For any other application in which a connector has to be released rapidly under load—for example, parachute connectors, connectors on harnesses for assembly workers or on other load-bearing belts or ropes, the underlying principle would be applicable. Depending on the area of application and maximum loads, the elements need only have larger or smaller dimensions or be modified in their external form.

### LIST OF REFERENCE SIGNS

1 load part
2 claw appendage
3 snap pocket
4 load part axis hole
5 blocking wedge recess
6 opening pin recess
7 pressure spring pin recess
8 spring chamber
9 protective flank
10 line eyelet
11 snap
12 snap axis hole
13 load arm
14 flat load area
15 steep load area
16 blocking arm
17 opening lug
18 closing cap
19 grip sleeve
20 right recessed grip
21 blocking wedge
22 opening pin
23 pressure spring pin
24 locking pin
25 left recessed grip
26 index finder rest
27 middle finger depression
28 axis
29 pressure spring
30 line
31 halter ring
32 thumb
33 index finger
34 middle finger

### DESCRIPTION OF DRAWINGS

FIG. 1 shows an enlargement of the panic snap according to the invention in the design for horse lead lines. The grip sleeve (19), comprising the right recessed grip (20) and the left recessed grip (25), surrounds the load part (1). The snap (11) mounted in the load part (1) and the claw appendage (2) molded on the load part (1) form a pincher, which holds the halter ring (31) in the closed state. The line (30) is braided through the line eyelet (10). The protective flanks (9) encase the snap (11). Visible are the closing cap (18), formed as a thumb rest, the index finger rest (26), and the middle finger depression (27).

FIG. 2 shows an exploded drawing of the panic snap according to the invention in its original size, with the individual parts, namely, the load part (1), the snap (11), the closing part (18), the right recessed grip (20), the left recessed grip (25), the axis (28), and the pressure spring (29). Visible are the snap pocket (3) and the load part axis hole (4) in the load part (1), the snap axis hole (12) in the snap (11), and the elements molded on the right recessed grip (20): blocking wedge (21), opening pin (22), pressure spring pin (23), and locking pin (24).

FIG. 3 shows the right recessed grip (20), into which the load part (1) is placed. The blocking wedge (21), the opening pin (22), and the pressure spring pin (23) project correspondingly through the blocking wedge recess (5), the opening pin recess (6), and the pressure spring pin recess (7) in the load part (1). The snap (11) is pushed into the snap pocket (3) of the load part (1) and mounted with the axis (28). The closing cap (18) is inserted onto the load part (1). The pressure spring (29) lies, with pretension on the pressure spring pin (23), in the spring chamber (8).

FIG. 4 shows cross-hatched the cross-sectional area of the load part (1) and the halter ring (31) in longitudinal section. The snap (11) rotates around the axis (28) in the snap pocket (3) and can assume various positions depending on the position of the grip sleeve (19). Here, the snap (11) is kept closed in that the pressure spring (29) presses the grip sleeve (19) in the direction of the snap (11) via the pressure spring pin (23) and thereby pushes the blocking wedge (21) under the blocking arm (16). The snap (11) is blocked in this position. When tensile force is applied to the load arm (13), the halter ring (31) slides on the steep load area (15) in the angle between flat load area (14) and claw appendage (2).

FIG. 5 shows the same view as FIG. 4 in the state before the snap (11) opens. The grip sleeve (19) is half pulled back against the spring force of the pressure spring (29) in the direction of the arrow. The blocking part (21) no longer blocks the blocking arm (16). The snap (11) is free and opens by itself when a tensile force is applied to the load arm (13) and then exposes the halter ring (31). Without pull on the load arm (13), the opening pin (22) strikes against the opening lug (17) in this phase and opens the snap (11) forcibly.

FIG. 6 shows the same view as FIG. 4 with the grip sleeve (19) completely pulled back. The pressure spring (29) is correspondingly compressed. The opening pin (22) holds the snap (11) in the maximum open position. The halter ring (31) can be snapped in place.

FIG. 7 shows how the user opens the panic snap according to the invention for snapping onto a halter ring (31). The thumb (32) pushes on the closing cap (18) to bring the load part (1) forward in the direction of the halter ring (31). At the same time, index finger (33) and middle finger (34), which rest on the index finger rest (26) and on the middle finger depression (27), respectively, pull the grip sleeve (19) back in the direction of the line (30), so that the snap (11) opens.

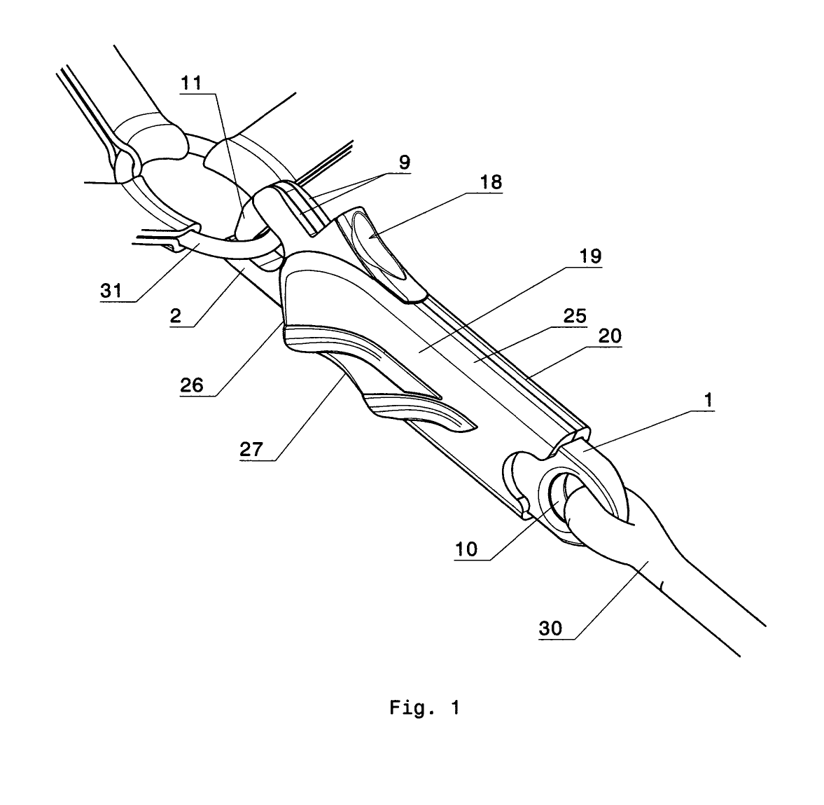

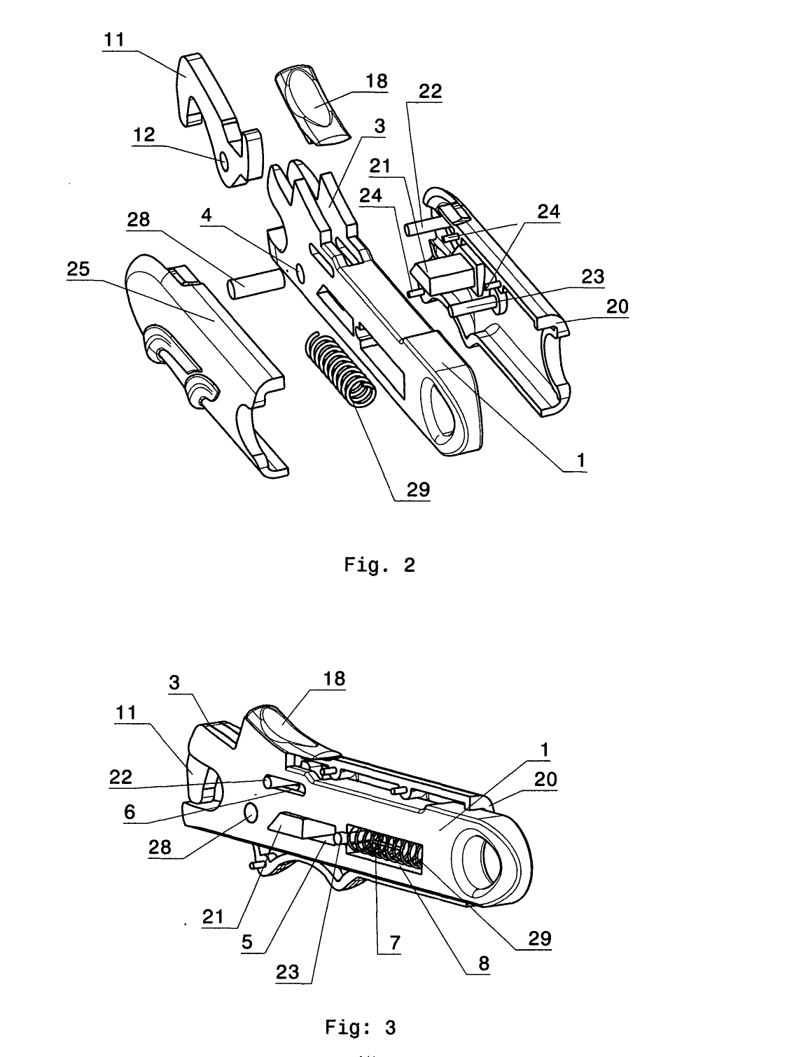

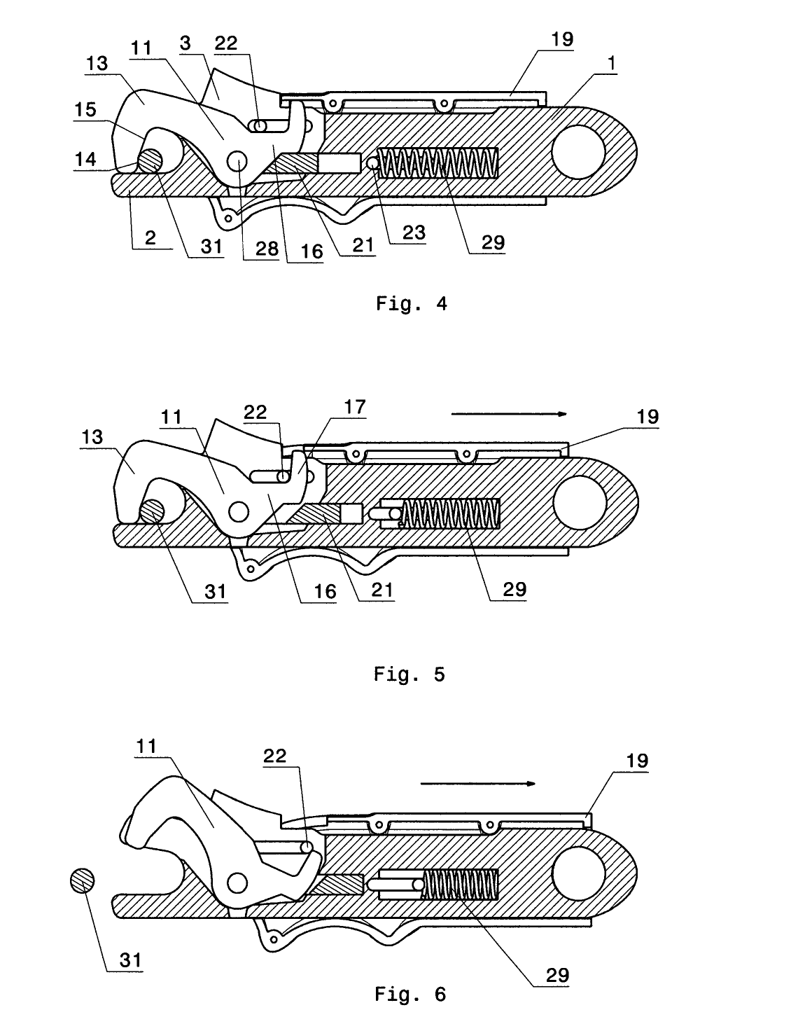

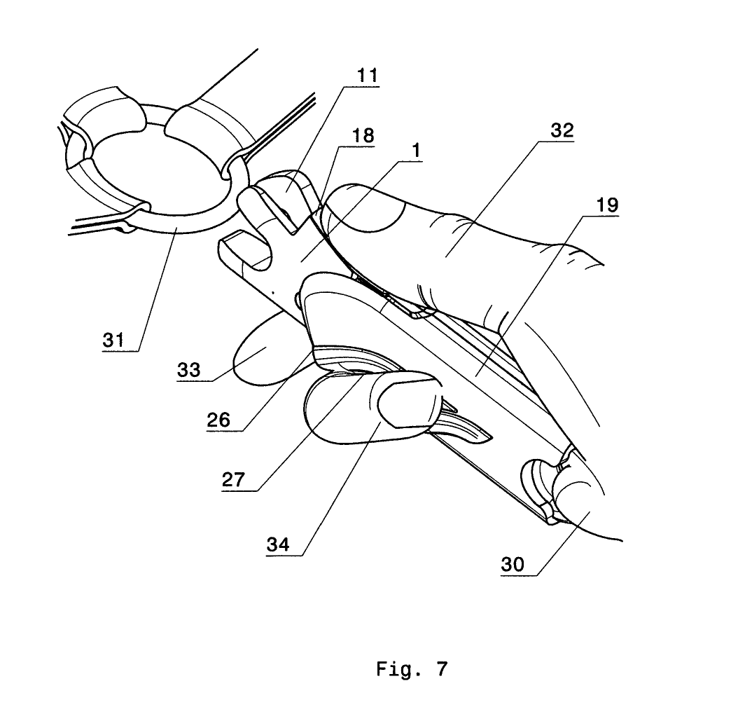

1. A panic snap, in particular for tether lines in horse keeping, with a rigid load part, a snap movably mounted on it, a displaceable unlocking element held in the closed position by spring force for opening the panic snap, and a fastening element for a line or belt, characterized in that the snap mounted in the load part is in the form of a rocker, one side of which forms a load arm and the other side of which forms a blocking arm, that the load arm has a steep load area, which transitions into a flat load area, that a claw appendage is molded on the load part, that the flat load area and the top side of the claw appendage form an interior angle of less than 90°, that the steep load area and the top side of the claw appendage form a smaller interior angle than that between the flat load area and the top side of the claw appendage, that the center of the cross section of an attached ring or the loop of a cord, the snap axis hole as point of rotation of the snap, and the middle of the cross section of the blocking wedge lie essentially on a line—the line of force—that an opening lug are molded on the unlocking element, that a blocking wedge and an opening pin are molded on the unlocking element, and that the load part has a blocking wedge recess and an opening pin recess.

2. The panic snap according to claim 1, further characterized in that the snap is fabricated of steel and that the load part and the unlocking element are fabricated of a lighter material, such as, for example, plastic reinforced with glass fiber.

3. The panic snap according to claims 1 and 2, further characterized in that a spring chamber for a pressure spring is formed in the load part, that the load part has a pressure spring pin recess, that a pressure spring pin is molded on the unlocking element, and that the pressure spring is tensioned between the pressure spring pin and the opposite-lying end of the spring chamber.

4. The panic snap according to claims 1 to 3, further characterized in that the pressure spring is tensioned directly between the blocking wedge and the opposite-lying end of the spring chamber.

5. The panic snap according to claims 1 to 4, further characterized in that the unlocking element is designed as an ergonomically formed grip sleeve, with an index finger rest and a middle finger depression, and that a thumb rest is molded on the load part.
